(19) United States
(12) Patent Application Publication
(10) Pub. No.: US 2009/0146787 A1
(43) Pub. Date: Jun. 11, 2009

(54) METHOD AND DEVICE FOR SETTING RFID PARAMETER

(75) Inventors: Chan-Won PARK, Daejeon (KR); Jeong Seok KIM, Daejeon (KR); Gil Young CHOI, Daejeon (KR); Cheol Sig PYO, Daejeon (KR); Jong-Suk CHAE, Daejeon (KR)

Correspondence Address: CANTOR COLBURN, LLP, 20 Church Street, 22nd Floor, Hartford, CT, 06103, US

(73) Assignee: Electronics and Telecommunications Research Institute, Daejeon (KR)

(21) Appl. No.: 12/203,426

(22) Filed: Sep. 3, 2008

(30) Foreign Application Priority Data
Dec. 10, 2007 (KR) 10-2007-0127786
Mar. 5, 2008 (KR) 10-2008-0020669

(51) Int. Cl. H04Q 5/22

(52) U.S. Cl. 340/10.1

(57) ABSTRACT

The present invention relates to an RFID parameter setting method and device in an RFID system including a first means for comparing a first mobile country code provided by the outside and a currently set second mobile country code, and generating a control signal for changing an RFID parameter setting of the RFID system according to the RFID standard that corresponds to the first mobile country code when the first mobile country code and the second mobile country code do not correspond with each other, and a second means for setting an operational frequency of the RFID system according to the control signal.

### CROSS-REFERENCE TO RELATED APPLICATION

This application claims priority to and the benefit of Korean Patent Application No. 10-2007-0127786 filed in the Korean Intellectual Property Office on Dec. 10, 2007, and No. 10-2008-0020669 filed therein on Mar. 5, 2008, the entire contents of which are incorporated herein by reference.

### BACKGROUND OF THE INVENTION

(a) Field of the Invention

The present invention relates to a radio frequency identification (RFID) parameter setting method and device in an RFID system, and more particularly, relates to a method and device for automatically setting an RFID parameter by using a mobile country code (MCC) included in a downlink signal of a mobile communication network.

This work was supported by the IT R&D program of MIC/IITA [2006-S-023-02, Development of Advanced RFID System Technology].

(b) Description of the Related Art

RFID is a skill for recognizing, tracking, and managing things, animals, or people to which an electronic tag is attached by reading or recording information from the tag (electronic tag or transponder) having proper identification information through a non-contact method by using radio frequency (RF) signals. A passive RFID system generally uses a frequency of 900 MHz bandwidth, and includes a plurality of tags that have proper identification information and are attached to a product, human, or animal, and an RFID reader (or interrogator) for reading or writing information of the tag.

A mobile RFID uses ultra high frequency (UHF) (860-960 MHz) bandwidth from among various radio frequency bandwidths for the RFID/USN (ubiquitous sensor network).

The domestic standard has selected the channel bandwidth of 200 kHz for each channel in the frequency bandwidth of 5.5 MHz of 908.5-915 MHz, and uses the European listen before talk (LBT) method together with the US frequency hopping (FH) method.

Table 1 expresses the frequency bandwidths allocated to different countries.

TABLE 1

| | Countries | | | | | | | |
|---|---|---|---|---|---|---|---|---|
| | ISO/ | | | | | | | |
| | IEC | US | EU | Australia | Brazil | China | Japan | Korea |
| Allocated | 860-960 | 902-928 MHz | 865.6-867.6 MHz | 920-926 MHz | 902-907.5 MHz | 840.5-844.5 MHz | 952-954 MHz | 908.5-914 MHz |
| frequency | MHz | 26Mz | (2 MHz) | (6 MHz) | 915-928 MHz | 920.5-924.5 MHz | 952-955 MHz | (5.5 MHz) |

As expressed in Table 1, the RFID system has different frequency ranges, outputs, and channel use methods for the respective countries. Therefore, it is required to reset the RFID parameters depending on the current country when a user moves between countries holding a mobile RFID phone. Particularly, when the frequency bandwidth used by the RFID reader of the mobile RFID phone corresponds to the mobile communication frequency bandwidth used in the corresponding area, the functions of the RFID reader cannot be used, and the mobile communication terminal of the mobile RFID phone may interfere with the RFID reader.

For example, since the global system for mobile communication (GSM) system uses the frequency bandwidth of 890-915 MHz for uplink and uses the frequency bandwidth of 935-960 MHz for downlink, many parts of the frequency bandwidths match the RFID frequency bandwidth used by many countries. Therefore, when the user moves from a country using the GSM system to another country using the RFID frequency range including the frequency bandwidth of the GSM system or vice versa, the mobile communication terminal of the mobile RFID phone and the RFID reader interfere with each other.

That is, the RFID frequencies or the outputs violating the standards of other countries cannot be used as a rule. Therefore, the RFID function cannot be used when the user moves between the countries using different RFID frequency bandwidths.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method for automatically setting an RFID parameter according to an RFID frequency bandwidth used by a corresponding country when moving between countries using different RFID frequency bandwidths.

An exemplary embodiment of the present invention provides an RFID parameter setting device of an RFID system including: a first means for comparing a first mobile country code provided by the outside and a currently set second mobile country code, and generating a control signal for changing RFID parameter setting of the RFID system according to the RFID standard that corresponds to the first mobile country code when the first mobile country code and the second mobile country code do not correspond with each other; and a second means for setting an operational frequency of the RFID system according to the control signal.

Another embodiment of the present invention provides an RFID parameter setting method of an RFID system including: receiving a signal from a base station; extracting a first mobile country code from the signal; and when the first mobile country code does not correspond to the currently set second mobile country code, changing the RFID parameter setting of the RFID system according to the RFID standard corresponding to the first mobile country code.

Yet another embodiment of the present invention provides an RFID parameter setting method of an RFID system including: receiving a first mobile country code; and when the first mobile country code does not correspond to the currently set second mobile country code, changing the RFID parameter setting of the RFID system according to the RFID standard corresponding to the first mobile country code.

According to the present invention, the RFID parameter of the RFID reader is set by the RFID standard of the corresponding country during roaming by the mobile RFID phone to prevent collision between the mobile communication frequency and the RFID frequency, and the RFID function can be used for movement between countries using different RFID frequency bandwidths.

### BRIEF DESCRIPTION OF THE DRAWINGS

FIG. 1 shows a block diagram of an RFID parameter setting device according to a first exemplary embodiment of the present invention.

FIG. 2 shows a flowchart of an RFID parameter setting method according to a second exemplary embodiment of the present invention.

FIG. 3 shows a flowchart of an RFID parameter setting method according to a third exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise”, and variations such as “comprises” and “comprising”, will be understood to imply the inclusion of stated elements but not the exclusion of any other elements. Also, the terms “unit”, “device”, and “module” in the present specification represent a unit for processing a predetermined function or operation, which can be realized by hardware, software, or a combination of hardware and software.

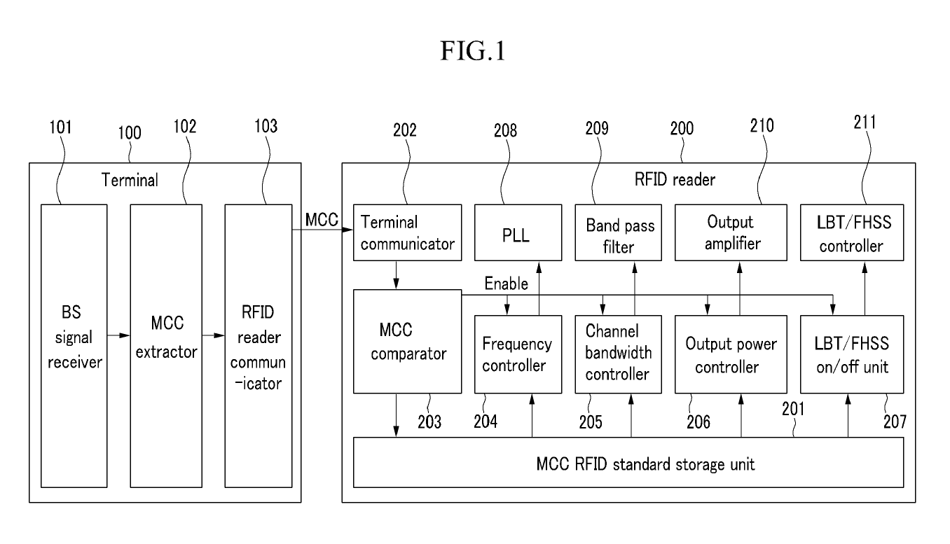

First, a RFID parameter setting device according to a first exemplary embodiment of the present invention will now be described with reference to FIG. 1. FIG. 1 shows a block diagram of the RFID parameter setting device according to the first exemplary embodiment of the present invention.

As shown in FIG. 1, the RFID parameter setting device includes a terminal 100 and an RFID reader 200.

The terminal 100 includes a base station signal receiver 101, an MCC extractor 102, and an RFID reader communicator 103. The base station signal receiver 101 receives a signal from the base station, the MCC extractor 102 extracts an MCC including serviced country information from the received signal, and the RFID reader communicator 103 transmits the extracted MCC to an RFID reader.

The RFID reader includes an MCC RFID standard storage unit 201, a terminal communicator 202, an MCC comparator 203, a frequency controller 204, a channel bandwidth controller 205, an output power controller 206, an LBT/FHSS (frequency hoping spread spectrum) on/off unit 207, a phase-locked loop (PLL) 208, a band pass filter 209, an output amplifier 210, and an LBT/FHSS controller 211.

The MCC RFID standard storage unit 201 stores RFID standards for the respective MCC's. That is, the MCC RFID standard storage unit 201 stores RFID parameters for the MCC including a frequency range, a channel width, a central frequency, a maximum power, an LBT usage state, an FHSS usage state, and an LBT/FHSS concurrent usage state.

The terminal communicator 202 receives an MCC from the terminal 100.

The MCC comparator 203 determines whether the MCC provided by the terminal 100 matches the existing MCC, and when they match with each other, it maintains the existing RFID reader frequency setting method, and when they do not, it refers to the MCC RFID standard storage unit 201 transmits a control signal for changing the RFID parameter setting of the RFID reader according to the RFID standard that corresponds to the MCC provided by the terminal 100 to the frequency controller 204, the channel bandwidth controller 205, the output power controller 206, and the LBT/FHSS on/off unit 207.

The frequency controller 204 changes the frequency setting of the PLL 208 according to the control signal provided by the MCC comparator 203 to set an operational frequency of the RFID reader 200, the channel bandwidth controller 205 controls the bandwidth of the band pass filter 209 according to the control signal provided by the MCC comparator 203, and the output power controller 206 controls the power of the output amplifier 210 according to the control signal provided by the MCC comparator 203. The LBT/FHSS on/off unit 207 sets the functions of the LBT and the FHSS.

The LBT/FHSS controller 211 receives the control signal from the LBT/FHSS on/off unit 207 to set the function so that the RFID reader may be operable by LBT or FHSS.

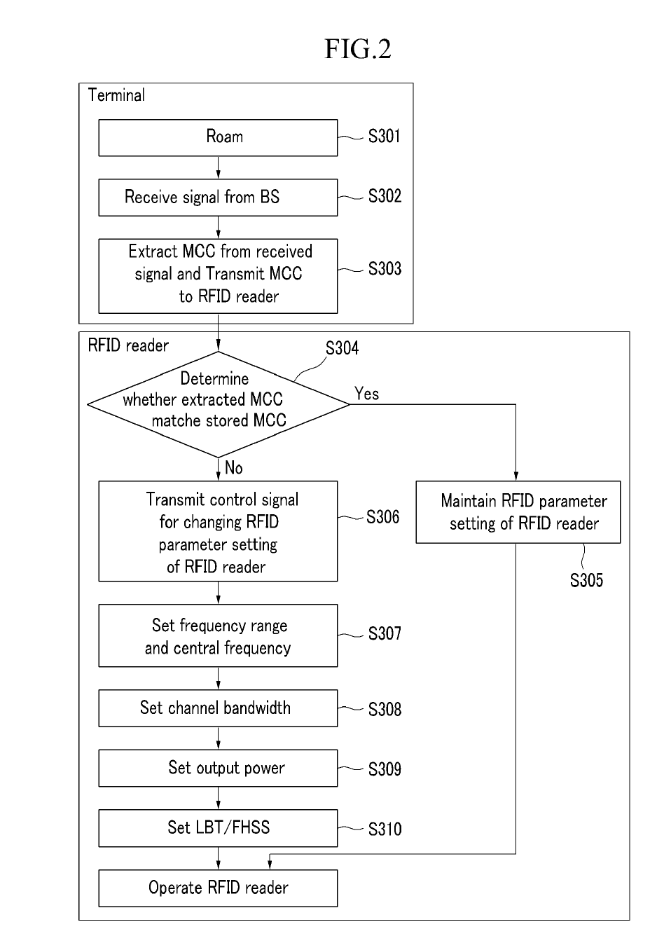

An RFID parameter setting method according to a second exemplary embodiment of the present invention will now be described with reference to FIG. 2. FIG. 2 shows a flowchart of an RFID parameter setting method according to a second exemplary embodiment of the present invention.

As shown in FIG. 2, when the terminal 100 roams (S301) and the base station signal receiver 101 receives a signal from the base station (S302), the MCC extractor 102 extracts the MCC from the received signal (S303). The signal received by the base station signal receiver 101 includes an MCC including country information, and it is used to identify the currently serviced country through the MCC.

The MCC comparator 203 compares the extracted MCC and the MCC stored in the RFID reader 200, that is, the MCC set in the RFID reader 200 to determine whether the extracted MCC corresponds to the MCC set in the RFID (S304). When the extracted MCC corresponds to the MCC set in the RFID, the RFID reader 200 maintains the RFID parameter setting (S305).

When the extracted MCC does not correspond to the MCC set in the RFID, the MCC comparator 203 finds an RFID standard corresponding to the MCC extracted from the MCC RFID standard storage unit 201, and transmits a control signal for changing the RFID parameter setting of the RFID reader 200 to the frequency controller 204, the channel bandwidth controller 205, the output power controller 206, and the LBT/FHSS on/off unit 207 (S306).

The frequency controller 204 sets the frequency range and central frequency of the RFID reader 200 according to the control signal (S307), the channel bandwidth controller 205 sets the channel bandwidth according to the control signal (S308), and the output power controller 206 sets the power of the output amplifier 210 according to the control signal (S309). The LBT/FHSS on/off unit 207 sets the LBT and FHSS function according to the control signal (S310).

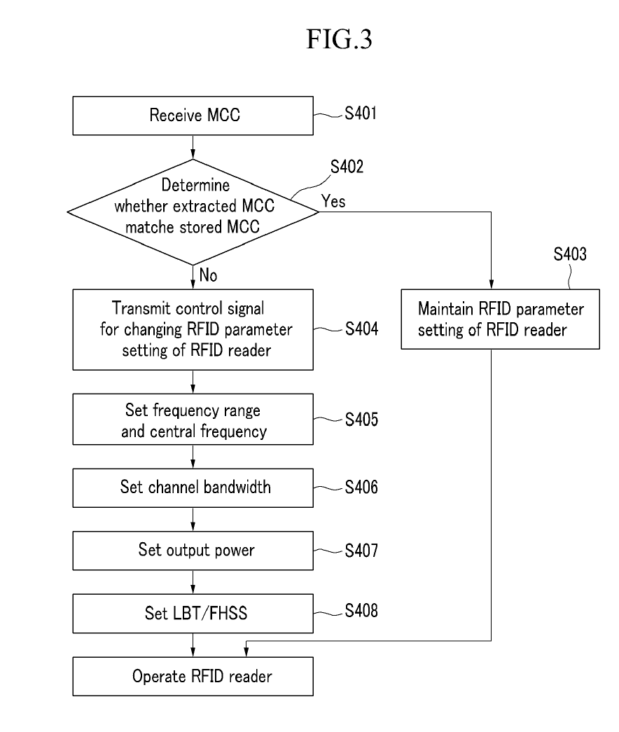

An RFID parameter setting method according to a third exemplary embodiment of the present invention will now be described with reference to FIG. 3. FIG. 3 shows a flowchart of an RFID parameter setting method according to a third exemplary embodiment of the present invention.

As shown in FIG. 3, an MCC is provided by a user (S401).

The MCC comparator 203 compares the input MCC and the MCC stored in the RFID reader 200, that is, the MCC set in the RFID reader 200, determines whether the extracted MCC corresponds to the MCC set in the RFID (S402), and when they correspond with each other, it maintains the RFID parameter setting (S403), and when they do not, it finds an RFID standard that corresponds to the MCC input by the MCC RFID standard storage unit 201 and transmits a control signal for changing the RFID parameter setting of the RFID reader 200 to the frequency controller 204, the channel bandwidth controller 205, the output power controller 206, and the LBT/FHSS on/off unit 207 (S404).

The frequency controller 204 sets a frequency range and a central frequency of the RFID reader 200 according to the control signal (S405), the channel bandwidth controller 205 sets the channel bandwidth according to the control signal (S406), and the output power controller 206 sets the power of the output amplifier 210 according to the control signal (S407). The LBT/FHSS on/off unit 207 sets the LBT and FHSS function according to the control signal (S408).

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An RFID parameter setting device of an RFID system comprising:
a first means for comparing a first mobile country code provided by the outside and a currently set second mobile country code, and generating a control signal for changing RFID parameter setting of the RFID system according to the RFID standard that corresponds to the first mobile country code when the first mobile country code and the second mobile country code do not correspond with each other; and
a second means for setting an operational frequency of the RFID system according to the control signal.

2. The RFID parameter setting device of claim 1, wherein the device further includes a third means for storing RFID standards for the respective first mobile country codes, and
the first means generates the control signal by referring to the RFID standards of the first mobile country codes stored in the third means.

3. The RFID parameter setting device of claim 2, further comprising
a fourth means for controlling a channel bandwidth of the RFID system according to the control signal.

4. The RFID parameter setting device of claim 2, further comprising
a fifth means for controlling an output power of the RFID system according to the control signal.

5. The RFID parameter setting device of claim 1, wherein
the first mobile country code is extracted from the signal received from the base station.

6. The RFID parameter setting device of claim 1, wherein
the first mobile country code is input by the user.

7. An RFID parameter setting method of an RFID system comprising:
receiving a signal from a base station;
extracting a first mobile country code from the signal; and
when the first mobile country code does not correspond to the currently set second mobile country code, changing the RFID parameter setting of the RFID system according to the RFID standard corresponding to the first mobile country code.

8. The RFID parameter setting method of claim 7, wherein the changing includes:
generating a control signal for changing the RFID parameter setting according to the RFID standard corresponding to the first mobile country code; and
setting an operational frequency of the RFID system according to the control signal.

9. The RFID parameter setting method of claim 8, wherein the changing further includes:
controlling a channel bandwidth of the RFID system according to the control signal; and
controlling an output power of the RFID system according to the control signal.

10. The RFID parameter setting method of claim 8, wherein
the generating includes generating the control signal by using the RFID standards of the stored first mobile country codes.

11. An RFID parameter setting method of an RFID system comprising:
receiving a first mobile country code; and
when the first mobile country code does not correspond to the currently set second mobile country code, changing the RFID parameter setting of the RFID system according to the RFID standard corresponding to the first mobile country code.

12. The RFID parameter setting method of claim 11, wherein
the RFID parameter includes an operational frequency of the RFID reader, a channel bandwidth, and an output power.
